(19) United States
(12) Patent Application Publication
(10) Pub. No.: US 2008/0204203 A1
(43) Pub. Date: Aug. 28, 2008

(54) Voice help-calling system of scooter

(76) Inventor: Fu-Long Hsu, Puzih City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/709,083

(22) Filed: Feb. 22, 2007

(51) Int. Cl. B60Q 1/00

(52) U.S. Cl. 340/425.5

(57) ABSTRACT

The present invention relates to a voice help-calling system of scooter, which comprises a help-calling switch, a CPU connected with the electronic system of the scooter and a voice IC connected with said help-calling switch and said CPU. Said voice IC is recorded with help-calling sound effect in advance, and then connected to an audio amplifier, in turn, to the speaker. In this manner, the voice help-calling system is triggered in case of uncomfortableness happened to the user or breakdown happened to scooter to effectively catch the attention of passerby for help.

### BACKGROUND OF THE INVENTION

1. Field of the Invention

The present invention relates to a voice help-calling system of scooter, more particularly to a voice help-calling system which is triggered in case of uncomfortableness happened to the user or breakdown happened to scooter etc. The help-calling sound effect sent out by the voice help-calling system will effectively catch the attention of passerby for help.

2. Brief Description of the Prior Art

In recent years, diversified auxiliary means have been developed to improve the living quality for aged people or handicapped person. For example, the presence of hearing aid earphone provides enhancement on the sense of hearing for hearing disabled person, and the electric scooter has gradually been replaced with a stick and wheelchair that are usually used by the person having degenerated physiological function or physical disability, and turned into the best means to help them save physical strength as well as the time for long distance travel.

While the electric scooter provides the convenience in long distance travel for users, however, casual breakdown of electric scooter is inevitable due to its complexity in design which is generally the combination of both mechanical and electronical components. Furthermore, electric scooter is sometimes carelessly entrapped into pit or hole in the roadway so that electric scooter is unable to move. In this case, it becomes very inconvenient for the aged people or handicapped person to handle these problems, as the aged people or the handicapped person is too weak to get off the scooter and get the scooter out from the pit, or move the scooter to the roadside with a purpose not to hinder the smoothness of traffic.

Aside from the inconvenience caused by the encountering of breakdown of the electric scooter, there is another issue concerning the burst out of body uncomfortableness or sudden disease during the driving of electric scooter. Since the physiological status of aged people or handicapped person is weaker than normal person, usually he is unable to take care of himself if body uncomfortableness or sudden disease happens during the driving of electric scooter. This might endanger to his life unless urgent assistance from the other people is obtained at the first instant of emergency.

In the case of emergency, the aged people or the handicapped person on the electric scooter can trigger the horn to catch the attention of passerby. However, car driver busying himself with commerce and industry in contemporary world often rushes and passes over. Only the triggering of horn is not enough to catch the attention of passerby. In addition, passerby fails to understand the need for a help of the aged people or the handicapped person from the triggering of the horn, consequently the chance to save their life is lost.

### SUMMARY OF THE INVENTION

The object of this invention is to provide a voice help-calling system for electric scooter, which provides a solution to the abovementioned problems encountered by the aged people or the handicapped person after continuous contemplation and design based on the experience and knowledge accumulated in the long term involvement of relevant field, and higher practical effectiveness of the electric scooter can certainly be expected.

The present invention relates to a voice help-calling system of scooter, which is used to effectively catch the attention of passerby for help at the moment of body uncomfortableness or the encountering of scooter breakdown happened to the person, driving the electric scooter, having degenerated physiological function or physical disability, wherein the voice help-calling system comprises a help-calling switch, a CPU, which is connected with the electronic system of the scooter, and a voice IC connected with the help-calling switch and the CPU.

Said voice IC is recorded with help-calling sound effect in advance, and then the voice IC is connected to an audio amplifier, in turn, to the speaker. Furthermore, a hearing-aid earphone is provided for the hearing disabled person so that the hearing disabled person can confirm the coming out of the help-calling sound effect and wait for assistance from enthusiastic passerby at ease. In this manner, the voice help-calling system is triggered to effectively catch the attention of passerby at the moment of body uncomfortableness or the encountering of scooter breakdown happened to the users.

### BRIEF DESCRIPTION OF THE DRAWINGS

The present invention will be better understood by the detailed description of preferred embodiments with reference to the accompanied drawings, in which:

FIG. 1 is a block diagram of the present invention.

FIG. 2 is a flow chart of the present invention.

### DETAILED DESCRIPTION OF THE PREFERRED EMBODIMENTS

The technical content, objects and effectiveness of the present invention will become more apparent by the detailed description of the following preferred embodiments of the present invention with reference to the accompanied drawings.

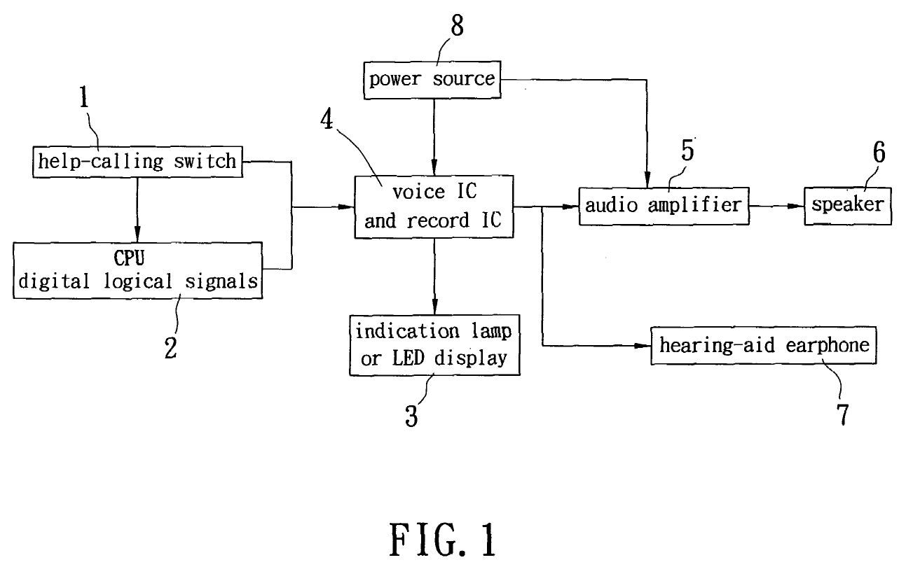

Firstly referring to FIG. 1, the voice help-calling system of the present invention is provided in the scooter and connected with the power source of the scooter. A help-calling switch 1 is provided in the voice help-calling system, which can be a push button. Further, the voice help-calling system has a CPU (Central Processing Unit) 2 which is connected with the electronic system of the scooter to receive the outputted signals from the electronic system. In turn, the help-calling switch 1 and the CPU 2 are connected to an indication lamp 3 provided on the control panel of the scooter and a voice IC 4 in which specific help-calling sound effect is recorded in advance. The voice IC 4 is then connected to an audio amplifier 5, the sound volume of which can be adjusted manually or set at a fixed decibel level. Then, the audio amplifier 5 is connected to a speaker 6, and a hearing-aid earphone 7 for the hearing disabled person is connected to the voice IC 4 as well.

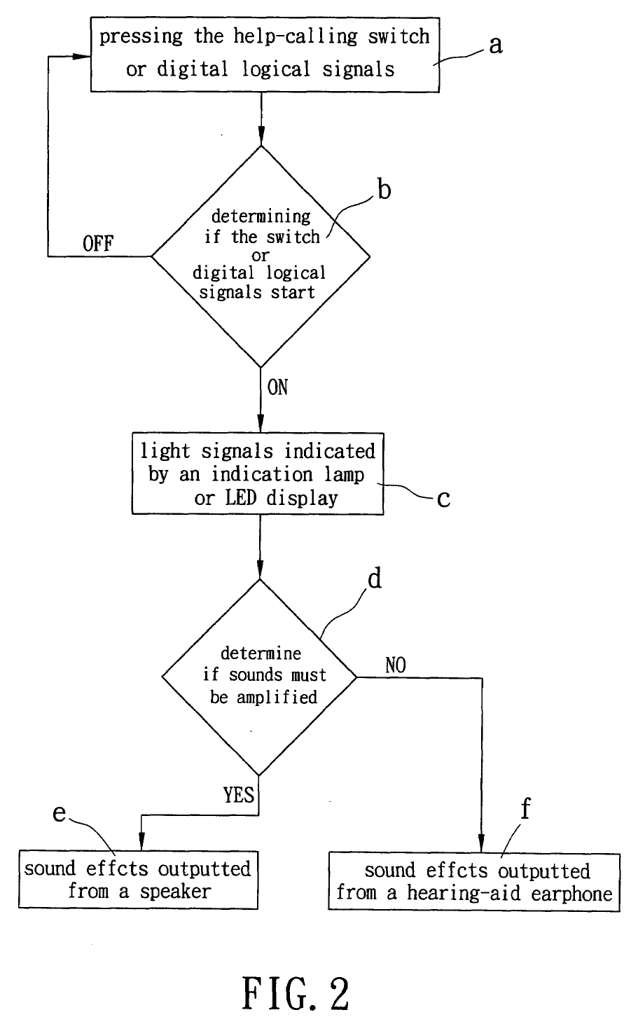

Then, the operation process of the voice help-calling system of the present invention will be described in conjunction with FIG. 2. In cases that the scooter has a breakdown or is entrapped into a pit or hole on a roadway, or the aged people and physically disabled person driving the scooter encounters body uncomfortableness or sudden disease,

(a). the help-calling switch 1 is pressed by the user;

(b). if the help-calling switch 1 is not activated, the process (a) must be repeated until the help-calling switch 1 is started;

(c). after the start of the help-calling switch 1, the light signals indicated by the indication lamp 3 connected to the control panel of the scooter and the specific help-calling sound effect recorded in the voice IC 4 in advance are activated respectively;

d). the sound effect outputted from the voice IC 4 is amplified by the audio amplifier 5 with a sound volume of fixed decibel level set in advance or with a sound volume manually adjusted by user himself;

e). the sound effect is then going through the speaker 6 and sent to the outside;

f). alternatively, the sound effect outputted from the voice IC 4 is directly outputted from the hearing-aid earphone 7 so that the hearing disabled person using the hearing-aid earphone 7 can confirm the triggering of voice IC 4 and wait for the assistance from enthusiastic passerby at ease.

In the other case that certain electronic component is out of order,

(A). a digital signal is transmitted to the CPU 2;

(B). next, the CPU 2 detects whether the digital signal is triggered or not, if not, then the process (A) is repeated again until the digital signal is triggered;

(C). after the digital signal is triggered, the CPU 2 trigger the light signals indicated by the indication lamp 3 connected to the control panel of the scooter. Thereby, user can notice of the breakdown of the scooter caused by the damage of certain electronic component within the scooter. Alternatively, the CPU 2 triggers the voice IC 4 to output an alarm sound effect recorded in response to the digital signal correspondingly, so as to inform the visual handicapped person about the damage of certain electronic component.

(D). the sound effect outputted from the voice IC 4 is amplified by the audio amplifier 5 with a sound volume of fixed decibel level set in advance or with a sound volume manually adjusted by user himself;

(E). the amplified sound effect is going through the speaker 6 and sent to the outside;

(F). alternatively, the sound effect outputted from the voice IC 4 is directly outputted from the hearing-aid earphone 7 so that the hearing disabled person using the hearing-aid earphone 7 can confirm the triggering of voice IC 4 and wait for assistance from enthusiastic passerby at ease.

In this manner, user driving the scooter can drive the scooter to roadside to avoid the traffic from hindering or to prevent the scooter from colliding by another car in the case the scooter is accidentally stopped in the center of a road.

Based on the foregoing structure and embodiment, the present invention has advantages listed as below

(1). The present invention provides a voice help-calling system on the scooter, in which a help-calling switch is pressed actively by user at the moment of the happening of body uncomfortableness or the encountering of scooter breakdown or the entrapping of scooter carelessly into a pit or hole on a roadway to activate the help-calling system sending out specific sound effect for help-calling, so as to effectively catch the attention of passerby for help.

(2). The voice help-calling system of the present invention provides speaker to send out amplified sound effect so as to call for assistance from passerby. Additionally, hearing-aid earphone is especially provided for hearing handicapped person so that the hearing disabled person using the hearing-aid earphone can confirm the triggering of voice IC and wait for assistance from enthusiastic passerby at ease.

(3). The voice help-calling system of the present invention includes indication light connected to the control pane of the scooter. In the case certain electronic component is out of order, a digital signal is sent out to the CPU. Next, the CPU will trigger the light signals indicated by the indication lamp connected to the control panel of the scooter. Thereby, user can notice of the breakdown caused by the damage of certain electronic component within the scooter, and ready to handle.

(4). In view of the fact that visual handicapped person is unable to learn the damage of certain electronic component from the light signals indicated by the indication lamp connected to the control panel of the scooter, an alarm sound effect is sent out so as to inform the visual handicapped person about the damage of certain electronic component, and ready to handle.

What is claimed is:

1. A voice help-calling system of scooter, which is provided in scooter and connected with the power source of the scooter, wherein the voice help-calling system comprises:
a help-calling switch;
a CPU, which is connected with the electronic system of the scooter; and
a voice IC, which is connected with said help-calling switch and said CPU,
said voice IC being recorded with help-calling sound effect in advance, then the voice IC being connected to a audio amplifier, in turn, to the speaker.

2. A voice help-calling system of scooter as claimed in claim 1, wherein said voice help-calling system of scooter further comprises an indication lamp provided on the control panel of scooter as well as connected with said CPU.

3. A voice help-calling system of scooter as claimed in claim 1, wherein said voice help-calling system of scooter further comprises a hearing-aid earphone connected with said voice IC.

4. A voice help-calling system of scooter as claimed in claim 1, wherein said help-calling switch is a push button.

5. A voice help-calling system of scooter as claimed in claim 1, wherein said audio amplifier can be set with a sound volume of fixed decibel.

6. A voice help-calling system of scooter as claimed in claim 1, wherein said audio amplifier can be adjusted a sound volume manually.
